(19) United States
(12) Patent Application Publication
(10) Pub. No.: US 2019/0069196 A1
(43) Pub. Date: Feb. 28, 2019

(54) CORE NODE, RADIO TERMINAL, COMMUNICATION METHOD, AND NON-TRANSITORY COMPUTER READABLE MEDIUM

(71) Applicant: NEC CORPORATION, Tokyo (JP)

(72) Inventors: Toru YAMADA, Tokyo (JP); Akira KAMEI, Tokyo (JP); Yumiko OKUYAMA, Tokyo (JP); Masahiro SERIZAWA, Tokyo (JP); Kyoji HIRATA, Tokyo (JP); Masashi SHIMOMA, Tokyo (JP); Satoshi HASEGAWA, Tokyo (JP)

(73) Assignee: NEC CORPORATION, Tokyo (JP)

(21) Appl. No.: 16/081,251

(22) PCT Filed: Nov. 28, 2016
(86) PCT No.: PCT/JP2016/004982

§ 371 Date: Aug. 30, 2018

(30) Foreign Application Priority Data
Mar. 3, 2016 (JP) 2016-040987

(51) Int. Cl. H04W 28/02; H04W 8/08; H04W 76/18; H04W 76/38

(52) U.S. Cl. CPC H04W 28/0289; H04W 28/0284; H04W 16/14; H04W 76/18; H04W 76/38; H04W 8/08

(57) ABSTRACT

The present disclosure aims to provide a core node capable of reducing the number of NAS request messages to be transmitted to the core node when a congestion state of the core node is continuing. A core node (10) according to the present disclosure includes: a congestion state detector (11) configured to detect a congestion state of the core node; a communication unit (13) configured to receive a NAS request message transmitted from a radio terminal (20); a message storing unit (14) configured to store the NAS request message; and a controller (12) configured to suspend processing regarding the NAS request message while the congestion state of the core node is being detected.

### TECHNICAL FIELD

The present disclosure relates to a core node, a radio terminal, a communication method, and a program, and more particularly, to a core node, a radio terminal, a communication method, and a program executing congestion control.

### BACKGROUND ART

A mobile communication system includes a radio terminal, a Radio Access Network (RAN), and a mobile core network. Further, the mobile core network includes a relay node that relays user plane data and a control node that relays control plane data. The relay node is, for example, a Serving Gateway (SGW), a Packet data network Gateway (PGW) and the like. The control node is, for example, a Mobility Management Entity (MME). The control node executes, for example, Mobility Management (MM), Session Management (SM) and the like. The relay node and the control node may be referred to as a core node.

The control node transmits Non-Access Stratum (NAS) messages to the radio terminal in order to execute the mobility management and the session management. The control node further receives the NAS message transmitted from the radio terminal. The NAS messages are control messages that are not terminated at the RAN and are transparently transmitted between the radio terminal and the MME without depending on the radio access technology of the RAN. Non-Patent Literature 1 discloses detailed descriptions regarding the NAS messages.

Non-Patent Literature 1 further discloses a technique regarding congestion control to reduce an overload or congestion in the mobile core network. When, for example, the MME receives a NAS message regarding the session management or the mobility management from the radio terminal in the state in which the MME is in the congestion state, the MME rejects processing regarding the NAS message that has been received. In this case, the MME transmits a reject message that specifies a back-off timer value to the radio terminal.

The radio terminal does not transmit the NAS message to the MME until the back-off timer value specified in the MME expires. In this way, the MME reduces the processing load in the congestion state.

### CITATION LIST

### Non-Patent Literature

[Non-Patent Literature 1] 3GPP TS23.401 V13.5.0 (2015-12)

### SUMMARY OF INVENTION

### Technical Problem

The radio terminal disclosed in Non-Patent Literature 1 re-transmits the NAS message to the core node after the back-off timer value has expired. However, the core node transmits the reject message to the radio terminal again when the congestion state of the own apparatus is continuing. Therefore, there is a problem that the processing load of the core node increases and the time recovered from the congestion state increases when the NAS message is re-transmitted while the congestion state is continuing.

The present disclosure aims to provide a core node, a radio terminal, a communication method, and a program capable of reducing the number of NAS request messages to be transmitted to the core node when the congestion state of the core node is being detected.

### Solution to Problem

A core node according to a first aspect of the present disclosure includes: a congestion state detector configured to detect a congestion state of an own apparatus; a communication unit configured to receive a NAS request message transmitted from a radio terminal; a message storing unit configured to store the NAS request message; and a controller configured to store the NAS request message in the message storing unit and suspend processing regarding the NAS request message while the congestion state of the own apparatus is being detected.

A radio terminal according to a second aspect of the present disclosure includes: a transmitter configured to transmit a NAS request message to a core node; and a receiver configured to receive a response message in response to the NAS request message, in which the transmitter does not transmit the NAS request message when it receives a Wait message indicating that processing regarding the NAS request message will be suspended from the core node and re-transmits the NAS request message to the core node when it receives, from the core node, a reject message indicating that the processing regarding the NAS request message will not be executed.

A communication method according to a third aspect of the present disclosure includes: detecting a congestion state of an own apparatus; receiving a NAS request message transmitted from a radio terminal; storing the NAS request message while the congestion state of the own apparatus is being detected; and suspending processing regarding the NAS request message while the congestion state of the own apparatus is being detected.

A program according to a fourth aspect of the present disclosure causes a computer to execute the following processing of: detecting a congestion state of an own apparatus; receiving a NAS request message transmitted from a radio terminal; storing the NAS request message while the congestion state of the own apparatus is being detected; and suspending processing regarding the NAS request message while the congestion state of the own apparatus is being detected.

### Advantageous Effects of Invention

According to the present disclosure, it is possible to provide a core node, a radio terminal, a communication method, and a program capable of reducing the number of NAS request messages to be transmitted to the core node when the congestion state of the core node is being detected.

### BRIEF DESCRIPTION OF DRAWINGS

FIG. 1 is a configuration diagram of a core node according to a first embodiment;

FIG. 2 is a configuration diagram of a communication system according to a second embodiment;

FIG. 3 is a diagram for describing a flow of processing in which an MME according to the second embodiment transmits a reject message;

FIG. 4 is a diagram for describing a flow of processing of a case in which the MME according to the second embodiment has recovered from a congestion state;

FIG. 5 is a configuration diagram of a UE according to the second embodiment;

FIG. 6 is a diagram for describing a flow of processing of stopping transmission of a NAS request message and processing of restarting the transmission of the NAS request message in the UE according to the second embodiment;

FIG. 7 is a diagram for describing a flow of processing when congestion occurs according to the second embodiment;

FIG. 8 is a diagram for describing a flow of processing when congestion occurs according to a third embodiment;

FIG. 9 is a configuration diagram of a UE 40 according to each of the embodiments; and

FIG. 10 is a configuration diagram of a core node 10 according to each of the embodiments.

### DESCRIPTION OF EMBODIMENTS

### First Embodiment

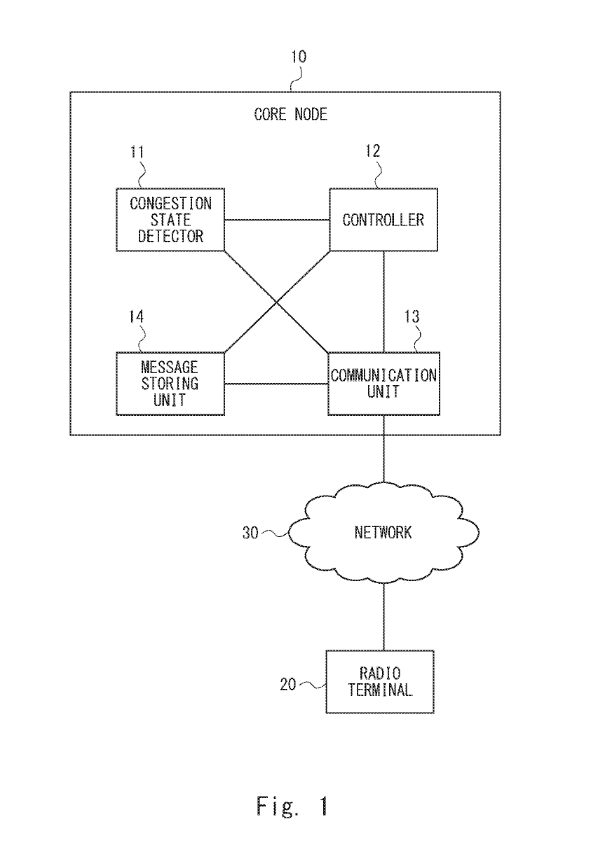

In the following description, with reference to the drawings, embodiments of the present disclosure will be explained. FIG. 1 shows a configuration example of a core node 10 according to a first embodiment of the present disclosure. The core node 10, which is a node arranged in a mobile core network, may be a control node or a relay node. The core node 10 may be a computer apparatus that is operated by a processor executing a program stored in a memory. The core node 10 communicates with a radio terminal 20 via a network 30.

The network 30 may be, for example, a RAN. The radio terminal 20 may be, for example, a mobile telephone terminal, a smart phone terminal, a tablet terminal, or a Machine to Machine (M2M) terminal that has a communication function. The M2M terminal may also be referred to as, for example, a Machine Type Communication (MTC) terminal.

The core node 10 includes a congestion state detector 11, a controller 12, a communication unit 13, and a message storing unit 14. The congestion state detector 11, the controller 12, the communication unit 13, and the message storing unit 14 may each be formed of software, a module or the like whose processing is executed by a processor executing a program stored in a memory. Alternatively, the congestion state detector 11, the controller 12, the communication unit 13, and the message storing unit 14 may each be formed of hardware such as a circuit or a chip.

The congestion state detector 11 detects the congestion state of the core node 10. The congestion state of the core node 10 may be a state in which the processing load of the core node 10 is high. The state in which the processing load is high may be, for example, a state in which the processor utilization, the memory utilization or the like of the core node 10 is higher than a predetermined threshold. Alternatively, the congestion state may be a state in which the number of messages transmitted or received in the core node 10 is larger than a predetermined threshold. Alternatively, the congestion state may be a state in which the number of radio terminals 20 managed or controlled by the core node 10 is larger than a predetermined threshold.

The communication unit 13 receives a NAS request message transmitted from the radio terminal 20. The NAS request message is a NAS message that is used in an Attach request, a session (bearer) request, or a location update request. The location update may be, for example, a Tracking Area Update (TAU) or a Routing Area Update (RAU).

The message storing unit 14 stores the NAS request message that the communication unit 13 has received during a period in which the congestion state is detected in the congestion state detector 11 and the congestion state in the core node 10 is being detected. The period in which the congestion state is detected may mean the period from the time the congestion state has been detected in the congestion state detector 11 to the time it is detected in the congestion state detector 11 that the core node 10 has recovered from the congestion state. Further, the message storing unit 14 temporarily stores the NAS request message in order to temporarily suspend the processing regarding the NAS request message.

The controller 12 suspends the processing regarding the NAS request message while the congestion state of the core node 10 is continuing. The processing regarding the NAS request message may be, for example, processing regarding an Attach request, a session request, or a location update request. Further, the controller 12 executes the processing regarding the NAS request message stored in the message storing unit 14 when the core node 10 has recovered from the congestion state. The message storing unit 14 stores the NAS request message that should be processed after the core node 10 has recovered from the congestion state while the congestion state is continuing.

As described above, the core node 10 according to the first embodiment of the present disclosure suspends processing regarding the NAS request message without transmitting the reject message for rejecting the processing regarding the NAS request message transmitted from the radio terminal 20 to the radio terminal 20 when the own apparatus is in the congestion state. Further, the core node 10 stores the NAS request message in the message storing unit 14. Accordingly, the core node 10 is able to use the NAS request message stored in the message storing unit 14 without causing the radio terminal 20 to re-transmit the NAS request message when the core node executes processing of the NAS request message transmitted from the radio terminal 20 after it recovers from the congestion state.

As a result, the core node 10 is able to avoid reception of the NAS request message re-transmitted from the radio terminal 20 while the congestion state is being detected, whereby it is possible to prevent the increase in the processing load.

### Second Embodiment

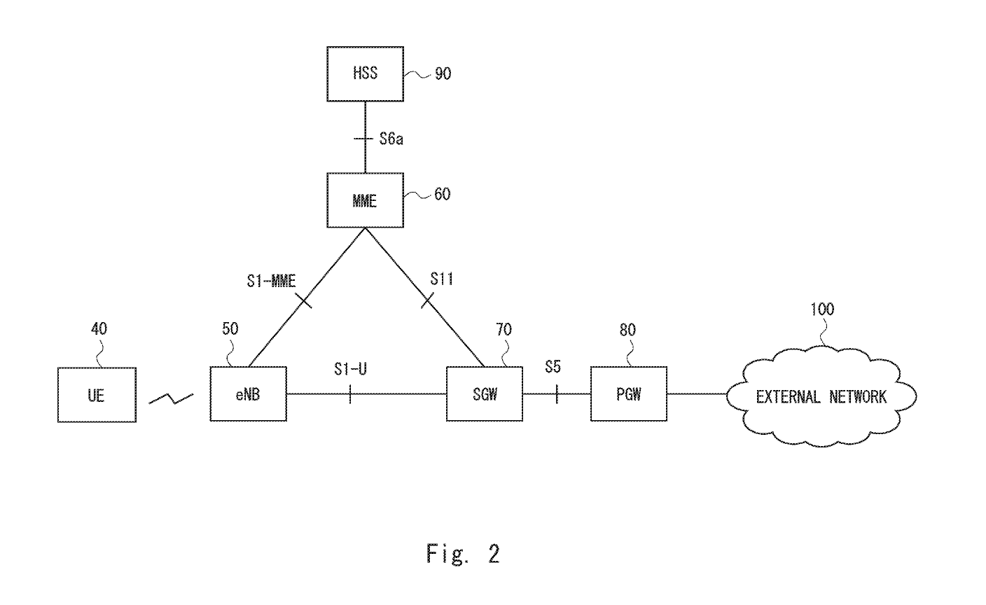

Next, with reference to FIG. 2, a configuration example of a communication system according to a second embodiment of the present disclosure will be explained. The communication system shown in FIG. 2 shows a configuration example of the communication system defined by the 3GPP, and includes a User Equipment (UE) 40, an eNB 50, an MME 60, an SGW 70, a PGW 80, a Home Subscriber Server (HSS) 90, and an external network 100. The UE 40 is used as a general term for the radio terminal in the 3GPP. The UE 40 corresponds to the radio terminal 20 shown in FIG. 1. The UE 40 may be, for example, an MTC device or the like. The eNB 50 is a base station that supports Long Term Evolution (LTE) defined by the 3GPP to be a radio access technology. The eNB 50 is arranged in the RAN.

The MME 60, the SGW 70, and the PGW 80 correspond to the core node 10 shown in FIG. 1. An S1-MME is defined as a reference point between the MME 60 and the eNB 50. An S1-U is defined as a reference point between the eNB 50 and the SGW 70. An S5 is defined as a reference point between the SGW 70 and the PGW 80.

The HSS 90 manages subscriber data regarding a plurality of UEs including the UE 40. The HSS 90 manages, for example, information regarding a plurality of Access Point Names (APNs) that can be specified by the respective UEs. An S6a is defined as a reference point between the HSS 90 and the MME 60.

The external network 100 is a network different from a mobile core network. The external network 100 may be, the so-called internet or a Packet Data Network (PDN). Further, the external network may be, for example, a network managed by a provider or the like that provides communication services for the UE 40. The communication service may be referred to as, for example, an application service, a cloud service, an internet service or the like. The provider that provides the communication service may be, for example, an Internet Service Provider (ISP), an Application Service Provider (ASP) or the like.

The APN is used as information for identifying the external network 100. That is, the UE 40 is able to communicate with a communication apparatus arranged in the external network 100 by specifying the APN that indicates the external network 100. In other words, the UE 40 is able to receive the service provided by the external network 100 by specifying the APN that indicates the external network 100.

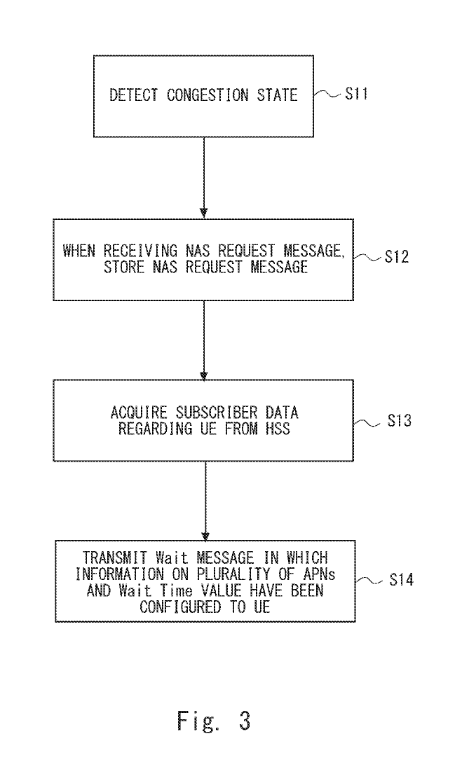

Next, with reference to FIG. 3, a flow of processing in which the MME 60 according to the second embodiment of the present disclosure transmits messages will be explained. The MME 60 has a configuration similar to that of the core node 10 in FIG. 1.

First, the congestion state detector 11 detects the congestion state in the MME 60 (S11). The MME 60 may execute, for example, mobility management congestion control of a NAS level executed in the overload state regardless of a specific APN as the congestion control. Specifically, the controller 12 rejects the NAS request message regarding session management or mobility management while the congestion state is continuing. In other words, the controller 12 does not execute the processing regarding the NAS request message while the congestion state is continuing.

Next, when the communication unit 13 receives the NAS request message transmitted from the UE 40 while the congestion state is continuing, the communication unit 13 stores the NAS request message that it has received in the message storing unit 14 (S12). Next, the communication unit 13 acquires subscriber data regarding the UE 40 from the HSS 90 (S13). The subscriber data regarding the UE 40 includes a plurality of APNs that can be specified by the UE 40. Alternatively, the subscriber data regarding the UE 40 may include all the APNs that can be specified by the UE 40.

Next, the communication unit 13 transmits a Wait message in which a plurality of APNs including the APN specified in the NAS request message received in Step S12 and a Wait Time value have been configured to the UE 40 (S14). The Wait message is a message indicating that the MME 60 should suspend processing regarding the NAS request message transmitted while the congestion state of the MME 60 is being continuing. Further, the Wait Time value indicates time during which the UE 40 suspends re-transmission after it has transmitted the NAS request message. The Wait Time value may also be referred to as a back-off timer value. Alternatively, the Wait Time value may indicate the time during which the UE 40 suspends the re-transmission of the NAS request message after the UE 40 has received the Wait message. That is, the UE 40 does not re-transmit the NAS request message to the MME 60 until the Wait Time value expires after it has transmitted the NAS request message.

Values different for each UE may be configured in the Wait Time value in accordance with a predetermined criterion. The controller 12 may count, for example, the number of NAS request messages that have been previously transmitted for each UE. Then the controller 12 may set the Wait Time value to be large when the number of NAS request messages exceeds the threshold and set the Wait Time value to be short when the number of NAS request messages does not exceed the threshold. Alternatively, the controller 12 may set the Wait Time value to be short when the number of NAS request messages exceeds the threshold and may set the Wait Time value to be large when the number of NAS request messages does not exceed the threshold.

Further, the UE 40 stops transmission of the NAS request message that has specified the plurality of APNs configured in the Wait message. The MME 60 is able to prevent reception of the re-transmission message of the NAS request message received in Step S12 by configuring the APN specified in the NAS request message received in Step S12 in the Wait message.

Further, the UE 40 is able to configure a plurality of APNs other than the APN specified in the NAS request message received in Step S12 in the Wait message. Accordingly, the MME 60 is able to reduce the number of NAS request messages to be received while the congestion state is being continuing.

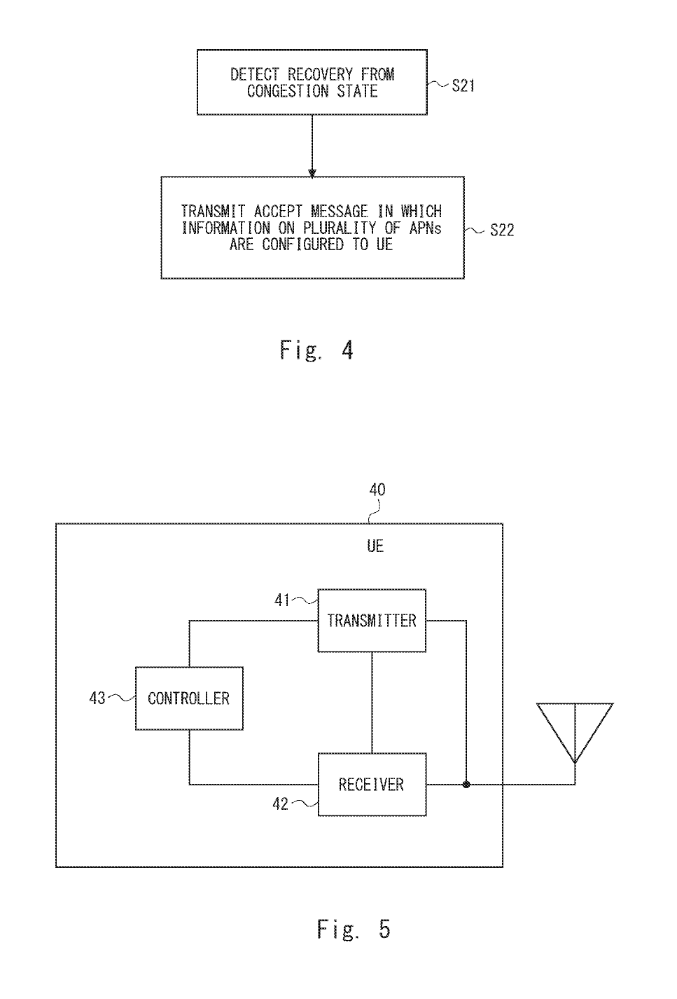

With reference next to FIG. 4, a flow of the processing of a case in which the MME 60 according to the second embodiment of the present disclosure has recovered from the congestion state will be explained. First, the congestion state detector 11 detects that the core node 10 has recovered from the congestion state (S21). The congestion state detector 11 may determine that the core node 10 has recovered from the congestion state when, for example, the number of NAS request messages that should be processed is below a predetermined threshold. Alternatively, the congestion state detector 11 may determine that the core node 10 has recovered from the congestion state when the processor utilization or the memory utilization of the core node 10 is below a predetermined threshold.

Next, the communication unit 13 transmits an Accept message in which the plurality of APNs configured in the Wait message have been configured to the UE 40 (S22). When it is detected in the congestion state detector 11 that the core node 10 has recovered from the congestion state, the controller 12 retrieves the NAS request message stored in the message storing unit 14. The controller 12 executes processing regarding the NAS request message that has been retrieved. When the processing regarding the NAS request message that has been suspended is completed, the communication unit 13 transmits the Accept message to the UE 40 in order to allow transmission of the NAS request message in which the APN configured in the Accept message has been specified.

The communication unit 13 may configure all the APNs configured in the Wait message in the Accept message or may configure some of the APNs configured in the Wait message in the Accept message.

There is a case, in which, for example, the MME 60 gradually recovers from the congestion state in accordance with the processor utilization, the memory utilization or the like. In this case, the communication unit 13 may transmit the Accept message to the UE 40 in accordance with the gradual recovery from the congestion state. The communication unit 13 may transmit, for example, the Accept message in each of the stage in which the MME 60 has recovered from the congestion state by 10%, the stage in which it has recovered by 30%, the stage in which it has recovered by 50%, and the stage in which it has recovered by 100%. Further, the communication unit 13 may configure some of the plurality of APNs configured in the Wait message in the Accept message transmitted in accordance with the gradual recovery from the congestion state. That is, the communication unit 13 may configure all the APNs configured in the Wait message in a plurality of Accept messages in a divided manner.

With reference next to FIG. 5, a configuration example of the UE 40 according to the second embodiment will be explained. The UE 40 includes a transmitter 41, a receiver 42, and a controller 43. The transmitter 41, the receiver 42, and the controller 43 may each be software, a module or the like whose processing is executed by a processor executing a program stored in a memory. Alternatively, the transmitter 41, the receiver 42, and the controller 43 may each be hardware such as a circuit or a chip.

The transmitter 41 transmits the NAS request message to the MME 60 via the eNB 50. The eNB 50 forwards the NAS request message to the MME 60 without terminating the NAS request message.

The receiver 42 receives a response message in response to the NAS request message transmitted from the MME 60 via the eNB 50. The response message in response to the NAS request message is, for example, the Wait message and the Accept message.

When the receiver 42 receives the Wait message indicating that the processing regarding the NAS request message should be suspended from the MME 60, the transmitter 41 does not transmit the NAS request message in which the APN configured in the Wait message has been specified to the MME 60. When, for example, APN_1 specified in the NAS request message that has been transmitted is configured in the Wait message, the transmitter 41 does not re-transmit the NAS request message in which APN_1 has been specified. Further, when an APN other than APN_1 is configured in the Wait message, the transmitter 41 does not transmit the NAS request message in which the APN configured in the Wait message has been specified as well.

The transmitter 41 does not perform transmission or re-transmission of the NAS request message before the Wait Time value configured in the Wait message expires. The controller 43 may start a timer after, for example, the transmitter 41 has received the NAS request message or it has received the Wait message in response to the NAS request message that has been transmitted. The transmitter 41 or the controller 43 may check whether the Wait Time value has expired using a timer that has been activated. The transmitter 41 may perform transmission or re-transmission of the NAS request message after the Wait Time value has expired.

Further, when the receiver 42 has received the Accept message, the transmitter 41 is able to transmit the NAS request message which specifies an APN other than the APN specified in the NAS request message that has been transmitted before to the MME 60. Alternatively, the controller 43 may stop the timer that has been activated when it has received the Accept message.

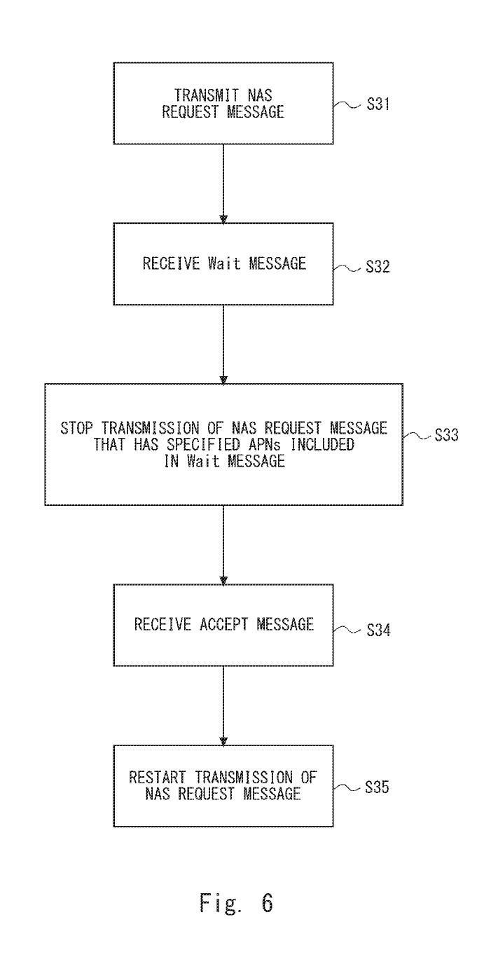

With reference next to FIG. 6, a flow of processing of stopping the transmission of the NAS request message in the UE 40 and processing of restarting the transmission of the NAS request message according to the second embodiment will be explained.

First, the transmitter 41 transmits the NAS request message to the eNB 50 via a radio communication line (S31). The transmitter 41 transmits the NAS request message in which the APN associated with the service to be used has been specified to the eNB 50. Next, the receiver 42 receives the Wait message from the MME 60 via the eNB 50 (S32). The plurality of APNs and the Wait Time value that are prohibited to be used are configured in the Wait message. The plurality of APNs configured in the Wait message also include the APN specified in the NAS request message transmitted in Step S31.

Next, the transmitter 41 stops transmission of the NAS request message in which the plurality of APNs configured in the Wait message are specified before the Wait Time value that has been specified expires (S33).

Next, the receiver 42 receives the ACCEPT message from the MME 60 via the eNB 50 (S34). A plurality of APNs that are available are configured in the ACCEPT message. The APNs configured in the ACCEPT message may be all the APNs configured in the Wait message or may be some of the plurality of APNs configured in the Wait message.

Next, the transmitter 41 restarts transmission of the NAS request message in which one APN selected from the plurality of APNs that are available has been configured (S35). The ACCEPT message is a message used to notify that the processing regarding the NAS request message transmitted in Step S31 has been completed. Therefore, the transmitter 41 may transmit a NAS request message in which an APN different from the APN configured in the NAS request message transmitted in Step S31 has been specified to the eNB 50 after it has received the ACCEPT message in the receiver 42.

The Wait Time value is configured in the Wait message that the receiver 42 has received in Step S32. The transmitter 41 may restart transmission of the NAS request message to the eNB 50 when the ACCEPT message is not transmitted even after the Wait Time value has expired. Alternatively, the transmitter 41 may stop transmission of the NAS request message to the eNB 50 until the time it receives the ACCEPT message if the ACCEPT message is not transmitted even after the Wait Time value has expired.

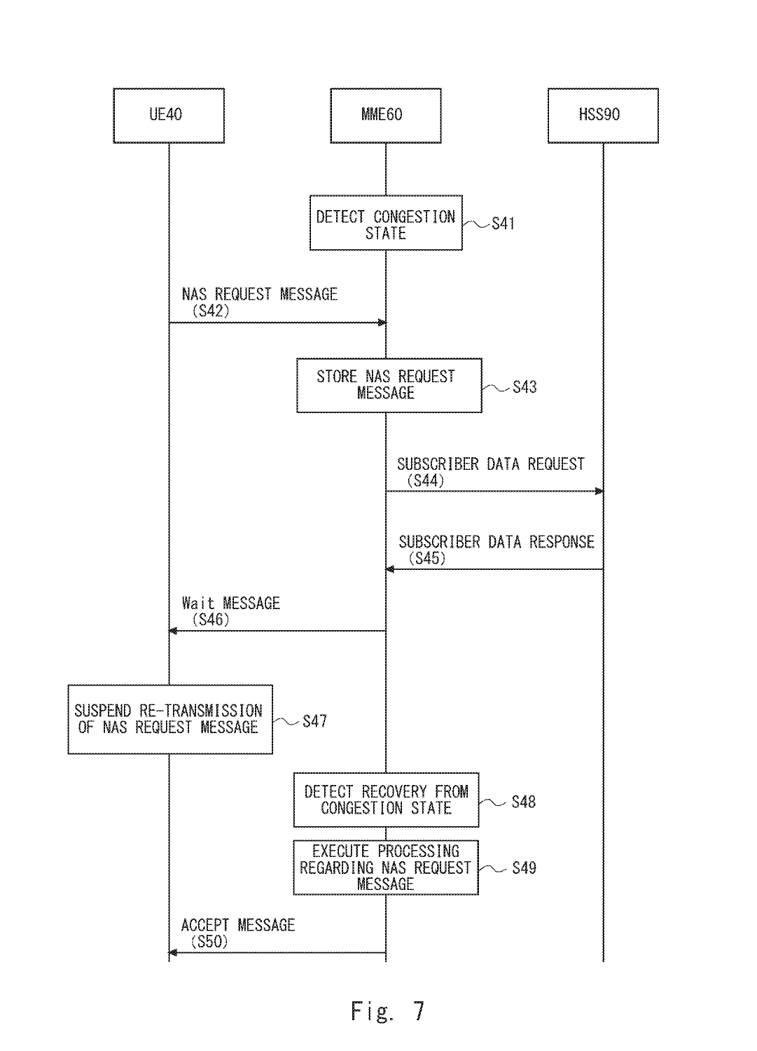

With reference next to FIG. 7, a flow of processing when the congestion occurs in the UE 40, the MME 60, and the HSS 90 according to the second embodiment of the present disclosure will be explained. While the communication between the UE 40 and the MME 60 is performed via the eNB 50, the eNB 50 is omitted in FIG. 7. First, the MME 60 detects the congestion state (S41). Next, the UE 40 transmits the NAS request message to the MME 60 via the eNB 50 (S42). The APN associated with the service that the UE 40 uses is configured in the NAS request message.

Next, the MME 60 stores the NAS request message received in Step S42 in the message storing unit 14 (S43). In other words, the MME 60 suspends the processing regarding the NAS request message received in Step S42.

Next, the MME 60 transmits a subscriber data request message to the HSS 90 in order to acquire the subscriber data of the UE 40 managed in the HSS 90 (S44). Identification information of the UE 40 is configured in the subscriber data request message. The identification information of the UE 40 may be, for example, International Mobile Subscriber Identity (IMSI).

Next, the HSS 90 transmits a subscriber data response message in which subscriber data including information regarding all the APNs that can be specified by the UE 40 has been configured to the MME 60 (S45). The HSS 90 configures subscriber data including only the information regarding a predetermined APN among all the APNs that can be specified by the UE 40 in the subscriber data response message when the APN regarding which a notification is sent in the subscriber data response message is predetermined. The predetermined APN may be a plurality of APNs. The predetermined APN may be defined in accordance with, for example, a criterion whether the frequency of the NAS message being transmitted is higher than a threshold. That is, the predetermined APN may be an APN that gives a large influence on the processing load in the MME 60.

Next, the MME 60 transmits the Wait message in which all the APNs included in the subscriber data have been configured to the UE 40 (S46). Alternatively, the MME 60 may configure, in accordance with a predetermined criterion, only the APN that has been specified in Step S42 and satisfies a criterion among all the APNs in the Wait message. The APN that satisfies the predetermined criterion may be, for example, the APN in which the frequency configured in the NAS request message is larger than a threshold.

Next, the UE 40 suspends transmission of the NAS request message regarding all the APNs configured in the Wait message (S47). In other words, the UE 40 stops transmission of the NAS request message in which the APN configured in the Wait message has been specified. Specifically, the UE 40 stops re-transmission of the NAS request message transmitted in Step S42, and transmission of the NAS request message in which APNs other than the APN specified in the NAS request message transmitted in Step S42, the APNs being configured in the Wait message, have been specified.

When all the APNs that can be used by the UE have been configured in the Wait message, the UE 40 stops transmission of all the NAS request messages.

Next, the MME 60 detects that it has recovered from the congestion state (S48). Next, the MME 60 executes the processing regarding the NAS request message that has been stored in Step S43 (S49). Next, the MME 60 transmits the ACCEPT message indicating that the processing regarding the NAS request message has been executed to the UE 40 (S50).

The UE 40 is able to transmit a NAS request message that has specified an APN other than the APN specified in the NAS request message in Step S42 after it has received the ACCEPT message.

As described above, the MME 60 according to the second embodiment of the present disclosure is able to store the received NAS request message in order to suspend the processing regarding the NAS request message received while the congestion state is being continuing. Further, the MME 60 is able to transmit the Wait message to the UE 40 while the NAS request message is being stored. Accordingly, the UE 40 is able to recognize that the processing regarding the NAS request message is being suspended, and the NAS request message is not re-transmitted. Therefore, the MME 60 needs not receive the NAS request message that has been re-transmitted, whereby it is possible to prevent the increase in the processing load, which is due to the reception of the NAS request message.

Further, the MME 60 is able to configure a plurality of APNs in the Wait message. Accordingly, the MME 60 is able to avoid reception of not only the re-transmission message regarding the NAS request message that has once been received but also the NAS request message in which an APN other than the APN specified in the NAS request message received once has been specified.

Further, the MME 60 is able to execute the processing regarding the NAS request message that has been stored when it has recovered from the congestion state. That is, the MME 60 does not need to request the UE 40 to re-transmit the NAS request message by storing the NAS request message whose processing has been suspended. It is therefore possible to reduce the number of messages transmitted between the UE 40 and the MME 60.

### Third Embodiment

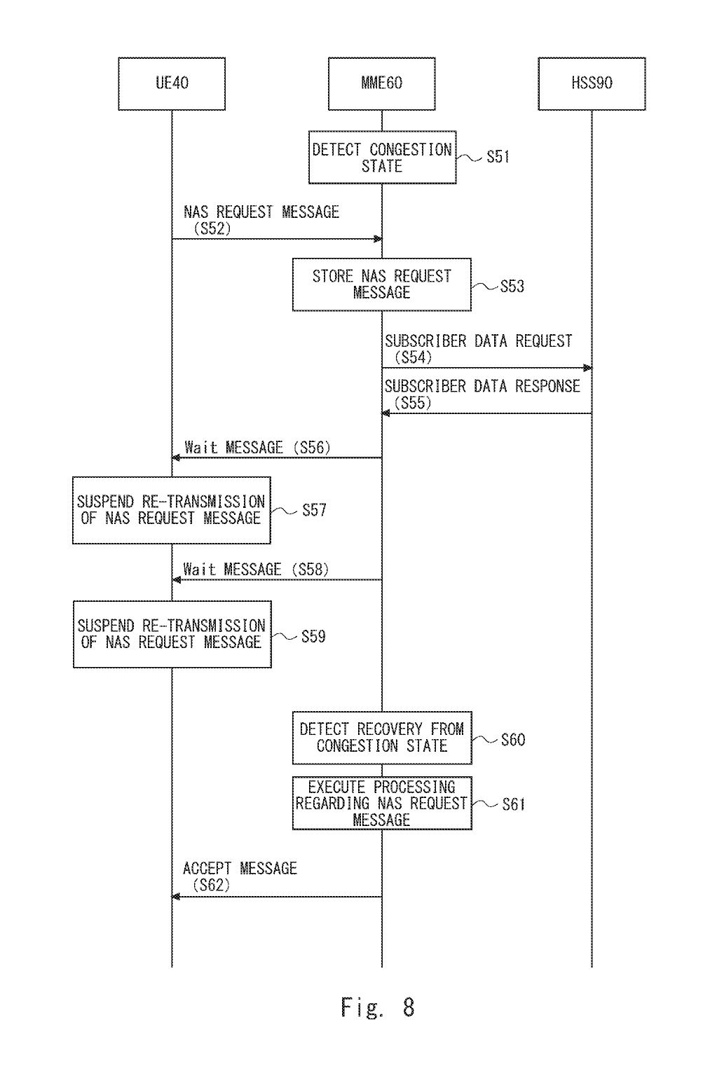

With reference next to FIG. 8, a flow of the processing in the UE 40, the MME 60, and the HSS 90 according to a third embodiment of the present disclosure when the congestion occurs will be explained. Since Steps S51-S57 are similar to Steps S41-S47 in FIG. 7, detailed descriptions thereof will be omitted.

The MME 60 transmits the Wait message to the UE 40 again when it has not yet recovered from the congestion state when the Wait Time value configured in the Wait message transmitted in Step S56 has expired (S58). When the UE 40 receives the Wait message in Step S58, the UE 40 suspends re-transmission of the NAS request message until the Wait Time value configured in the Wait message that has been received expires (S59).

Since Steps S60-S62 are similar to Steps S48-S50 in FIG. 7, detailed descriptions thereof will be omitted.

While the example in which the MME 60 transmits the Wait message twice has been described in FIG. 7, the MME 60 may transmit the Wait message to the UE 40 three or more times. Further, the MME 60 may define the maximum number of times the Wait message can been transmitted in advance. When the number of times the Wait message is transmitted has reached the upper-limit value, the MME 60 may discard the stored NAS request messages and transmit the REJECT message to the UE 40. The REJECT message is a message that is used to notify the UE 40 that the execution of the processing regarding the NAS request message has been rejected. The MME 60 may set the back-off timer value in the REJECT message.

Further, when the MME 60 which is in the congestion state receives the NAS request message from the UE 40, the MME 60 may transmit the Wait message to the UE 40 and notifies the UE 40 that the NAS request message has been suspended while the number of NAS request messages that have been received does not exceed the number of NAS request messages that can be suspended. When the number of NAS request messages that have been received exceeds the number of NAS request messages that can be suspended, the MME 60 may transmit the Reject message to the UE 40, thereby notifying the UE 40 that the NAS request message has been disposed of.

Upon receiving the REJECT message, the UE 40 re-transmits the NAS request message after the back-off timer value configured in the REJECT message has expired. Alternatively, the UE 40 may transmit the NAS request message in which an APN other than the APN specified in the NAS request message transmitted in Step S52 has been specified to the MME 60.

The REJECT message is a message defined in the 3GPP as a message transmitted when the processing regarding the NAS request message is rejected. The MME 60 may newly define a Cancel message or the like as a message for notifying the UE 40 that the stored NAS request messages have been discarded when the number of times the Wait message is transmitted has reached the upper-limit value. That is, the MME 60 may use the REJECT message already defined in the 3GPP or may use a new message that has not been defined in the 3GPP as a message for notifying the UE 40 that the stored NAS request messages have been discarded when the number of times the Wait message is transmitted has reached the upper-limit value.

Further, when the UE 40 has received the Wait message, the MME 60 may define a Cancel message as a message for requesting cancellation of the NAS request message suspended for the MME 60. When the MME 60 receives the Cancel message from the UE 40, the MME 60 disposes of the NAS request messages that have already been received from the UE 40 and suspended and transmits the Reject message to the UE 40. In this case, the Cancel message may include information regarding which NAS request message should be discarded.

As described above, the MME 60 according to the third embodiment of the present disclosure is able to transmit the Wait message a plurality of times before it recovers from the congestion state. Further, the MME 60 is able to transmit the REJECT message or the Cancel message to the UE 40 when the number of times the Wait message is transmitted has reached the upper limit. Accordingly, the MME 60 is able to cause the UE 40 to restart the transmission of the NAS request message.

Next, in the following description, configuration examples of the core node 10 and the UE 40 described in the aforementioned embodiments will be explained.

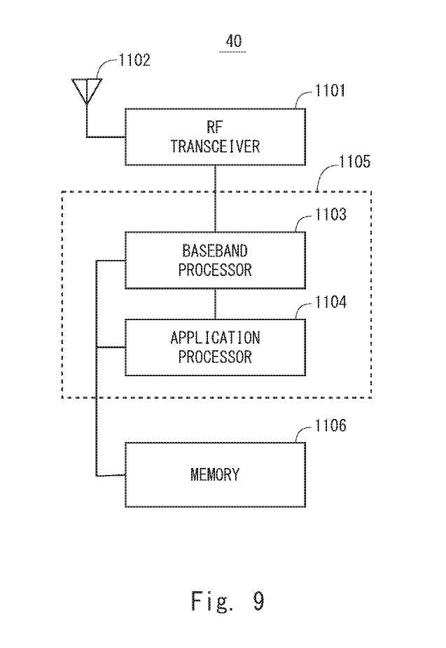

FIG. 9 is a block diagram showing the configuration example of the UE 40. A Radio Frequency (RF) transceiver 1101 performs analog RF signal processing to communicate with the eNB 50. The analog RF signal processing performed by the RF transceiver 1101 includes frequency up-conversion, frequency down-conversion, and amplification. The RF transceiver 1101 is coupled to an antenna 1102 and a baseband processor 1103. That is, the RF transceiver 1101 receives modulated symbol data (or OFDM symbol data) from the baseband processor 1103, generates a transmission RF signal, and supplies the transmission RF signal to the antenna 1102. Further, the RF transceiver 1101 generates a baseband reception signal based on a reception RF signal received by the antenna 1102, and supplies the baseband reception signal to the baseband processor 1103.

The baseband processor 1103 performs digital baseband signal processing (i.e., data plane processing) and control plane processing for radio communication. The digital baseband signal processing includes (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). On the other hand, the control plane processing includes communication management of layer 1 (e.g., transmission power control), layer 2 (e.g., radio resource management and hybrid automatic repeat request (HARQ) processing), and layer 3 (e.g., signalling regarding attach, mobility, and call management).

In the case of LTE and LTE-Advanced, for example, the digital baseband signal processing by the baseband processor 1103 may include signal processing of a Packet Data Convergence Protocol (PDCP) layer, a Radio Link Control (RLC) layer, a MAC layer, and a PHY layer. Further, the control plane processing by the baseband processor 1103 may include processing of a Non-Access Stratum (NAS) protocol, an RRC protocol, and MAC CE.

The baseband processor 1103 may include a modem processor (e.g., a Digital Signal Processor (DSP)) that performs the digital baseband signal processing and a protocol stack processor (e.g., a Central Processing Unit (CPU) or a Micro Processing Unit (MPU)) that performs the control plane processing. In this case, the protocol stack processor, which performs control plane processing, may be integrated with an application processor 1104 described in the following.

The application processor 1104 is also referred to as a CPU, an MPU, a microprocessor, or a processor core. The application processor 1104 may include a plurality of processors (processor cores). The application processor 1104 loads a system software program (Operating System (OS)) and various application programs (e.g., a voice call application, a WEB browser, a mailer, a camera operation application, and a music player application) from a memory 1106 or from another memory (not shown) and executes these programs, thereby providing various functions of the UE 40.

In some implementations, as represented by a dashed line (1105) in FIG. 9, the baseband processor 1103 and the application processor 1104 may be integrated on a single chip. In other words, the baseband processor 1103 and the application processor 1104 may be implemented in a single System on Chip (SoC) device 1105. An SoC device may be referred to as a system Large Scale Integration (LSI) or a chipset.

The memory 1106 is a volatile memory, a non-volatile memory, or a combination thereof. The memory 1106 may include a plurality of memory devices that are physically independent from each other. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 1106 may include, for example, an external memory device that can be accessed from the baseband processor 1103, the application processor 1104, and the SoC 1105. The memory 1106 may include an internal memory device that is integrated in the baseband processor 1103, the application processor 1104, or the SoC 1105. Further, the memory 1106 may include a memory in a Universal Integrated Circuit Card (UICC).

The memory 1106 may store a software module (computer program) including instructions and data for performing processing by the UE 40 described in the aforementioned embodiments. In some implementations, the baseband processor 1103 or the application processor 1104 may load the software module from the memory 1106 and execute the loaded software module, thereby performing the processing of the UE 40 described in the aforementioned embodiments.

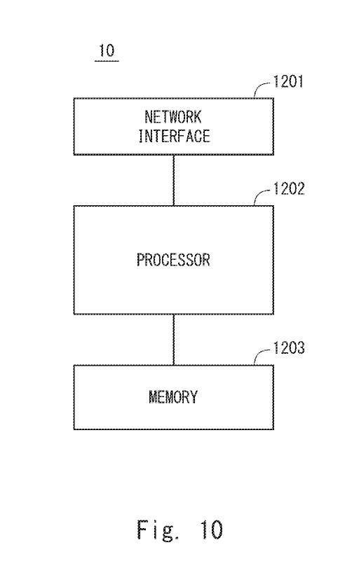

FIG. 10 is a block diagram showing the configuration example of the core node 10. Referring to FIG. 10, the core node 10 includes a network interface 1201, a processor 1202, and a memory 1203. The network interface 1201 is used to communicate with the network node (e.g., eNB, MME, SGW, P-GW). The network interface 1201 may include, for example, a network interface card (NIC) conforming to the IEEE 802.3 series.

The processor 1202 loads software (computer program) from the memory 1203 and executes the loaded software, thereby performing the processing of the core node 10 described with reference to the sequence diagrams and flowcharts in the aforementioned embodiments. The processor 1202 may be, for example, a microprocessor, an MPU, or a CPU. The processor 1202 may include a plurality of processors.

The memory 1203 is composed of a combination of a volatile memory and a non-volatile memory. The memory 1203 may include a storage that is located apart from the processor 1202. In this case, the processor 1202 may access the memory 1203 via an I/O interface (not shown).

In the example shown in FIG. 10, the memory 1203 is used to store software modules. The processor 1202 loads these software modules from the memory 1203 and executes these loaded software modules, thereby performing the processing of the core node 10 described in the aforementioned embodiments.

As described above with reference to FIGS. 9 and 10, each of the processors included in the UE 40 and the core node 10 according to the aforementioned embodiments executes one or more programs including instructions to cause a computer to perform an algorithm described with reference to the drawings.

In the aforementioned examples, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The present disclosure is not limited to the aforementioned embodiments and may be changed as appropriate without departing from the spirit of the present disclosure.

While the present disclosure has been described with reference to the embodiments, the present disclosure is not limited to the aforementioned embodiments. Various changes that can be understood by those skilled in the art can be made to the configurations and the details of the present disclosure within the scope of the present disclosure.

This application is based upon and claims the benefit of priority from Japanese Patent Application No. 2016-040987, filed on Mar. 3, 2016, the disclosure of which is incorporated herein in its entirety by reference.

For example, the whole or part of the embodiments disclosed above can be described as, but not limited to, the following supplementary notes.

### (Supplementary Note 1)

A core node comprising:

a congestion state detector configured to detect a congestion state of an own apparatus;

a communication unit configured to receive a NAS request message transmitted from a radio terminal;

a message storing unit configured to store the NAS request message; and

a controller configured to store the NAS request message in the message storing unit and suspend processing regarding the NAS request message while the congestion state of the own apparatus is being detected.

### (Supplementary Note 2)

The core node according to Supplementary Note 1, wherein the controller executes the processing regarding the NAS request message stored in the message storing unit when the own apparatus has recovered from the congestion state.

### (Supplementary Note 3)

The core node according to Supplementary Note 1 or 2, wherein the communication unit transmits a Wait message notifying the radio terminal that the processing regarding the NAS request message will be suspended when it is determined that the processing regarding the NAS request message will be suspended in the controller.

### (Supplementary Note 4)

The core node according to Supplementary Note 3, wherein the communication unit transmits a plurality of Wait messages to the radio terminal before the processing regarding the NAS request message is executed.

### (Supplementary Note 5)

The core node according to Supplementary Note 3 or 4, wherein the controller determines not to perform the processing regarding the NAS request message when the number of times the Wait message is transmitted has reached an upper-limit value, and the communication unit transmits a reject message indicating that the processing regarding the NAS request message will not be executed to the radio terminal.

### (Supplementary Note 6)

The core node according to Supplementary Note 4 or 4, wherein the communication unit transmits the Wait message in which a back-off timer value has been configured to the radio terminal, and transmits a new Wait message in which a back-off timer value is configured to the radio terminal when the congestion state of the own apparatus is continuing at a timing when the back-off timer value has expired.

### (Supplementary Note 7)

The core node according to any one of Supplementary Notes 2 to 6, wherein the communication unit transmits an accept message to the radio terminal when the own apparatus has recovered from the congestion state and the processing regarding the NAS request message has been completed.

### (Supplementary Note 8)

A radio terminal comprising:

a transmitter configured to transmit a NAS request message to a core node; and

a receiver configured to receive a response message in response to the NAS request message, wherein

the transmitter does not transmit the NAS request message when it receives a Wait message indicating that processing regarding the NAS request message will be suspended from the core node and re-transmits the NAS request message to the core node when it receives, from the core node, a reject message indicating that the processing regarding the NAS request message will not be executed.

### (Supplementary Note 9)

The radio terminal according to Supplementary Note 8, wherein the transmitter re-transmits the NAS request message to the core node after the back-off timer value configured in the reject message has expired.

### (Supplementary Note 10)

A communication method in a core node, the method comprising:

detecting a congestion state of an own apparatus; receiving a NAS request message transmitted from a radio terminal;

storing the NAS request message while the congestion state of the own apparatus is being detected; and

suspending processing regarding the NAS request message while the congestion state of the own apparatus is being detected.

### (Supplementary Note 11)

The communication method in the core node according to Supplementary Note 10, comprising executing the processing regarding the NAS request message that has been stored when the own apparatus has recovered from the congestion state.

### (Supplementary Note 12)

A communication method in a radio terminal, the method comprising:

transmitting a NAS request message to a core node; and

receiving a response message in response to the NAS request message,

wherein, when the response message has been received, the NAS request message is not transmitted when a Wait message indicating that processing regarding the NAS request message will be suspended is received from the core node and the NAS request message is re-transmitted to the core node when a reject message indicating that the processing regarding the NAS request message will not be executed is received from the core node.

### (Supplementary Note 13)

A program for causing a computer to execute the following processing of:

detecting a congestion state of an own apparatus;

receiving a NAS request message transmitted from a radio terminal;

storing the NAS request message while the congestion state of the own apparatus is being detected; and

suspending processing regarding the NAS request message while the congestion state of the own apparatus is being detected.

### (Supplementary Note 14)

The program according to Supplementary Note 13, comprising causing a computer to further execute the processing regarding the NAS request message that has been stored when the own apparatus has recovered from the congestion state.

### (Supplementary Note 15)

A program for causing a computer to execute the following processing of:

transmitting a NAS request message to a core node; and

receiving a response message in response to the NAS request message,

wherein, when the response message has been received, the NAS request message is not transmitted when a Wait message indicating that processing regarding the NAS request message will be suspended is received from the core node and the NAS request message is re-transmitted to the core node when a reject message indicating that the processing regarding the NAS request message will not be executed is received from the core node.

### REFERENCE SIGNS LIST

10 CORE NODE
11 CONGESTION STATE DETECTOR
12 CONTROLLER
13 COMMUNICATION UNIT
14 MESSAGE STORING UNIT
20 RADIO TERMINAL
30 NETWORK
40 UE
41 TRANSMITTER
42 RECEIVER
43 CONTROLLER
50 eNB
60 MME
70 SGW
80 PGW
90 HSS
100 EXTERNAL NETWORK

1. A core node comprising:
at least one memory storing instructions, and
at least one processor configured to execute the instructions to;
detect a congestion state of the core node;
receive a Non-Access Stratum (NAS) request message transmitted from a radio terminal;
store the NAS request message; and
store the NAS request message in the message storing means and suspending processing regarding the NAS request message while the congestion state of the core node is being detected.

2. The core node according to claim 1, wherein the at least one processor is further configured to execute the instructions to execute the processing regarding the NAS request message when the core node has recovered from the congestion state.

3. The core node according to claim 1, wherein the at least one processor is further configured to execute the instructions to transmit a Wait message notifying the radio terminal that the processing regarding the NAS request message will be suspended when it is determined that the processing regarding the NAS request message will be suspended in the control means.

4. The core node according to claim 3, wherein the at least one processor is further configured to execute the instructions to transmit a plurality of Wait messages to the radio terminal before the processing regarding the NAS request message is executed.

5. The core node according to claim 3, wherein the at least one processor is further configured to execute the instructions to determine not to perform the processing regarding the NAS request message when the number of times the Wait message is transmitted has reached an upper-limit value, and transmit a reject message indicating that the processing regarding the NAS request message will not be executed to the radio terminal.

6. The core node according to claim 4, wherein the at least one processor is further configured to execute the instructions to transmit the Wait message in which a back-off timer value has been configured to the radio terminal, and transmit a new Wait message in which a back-off timer value is configured to the radio terminal when the congestion state of the core node is continuing at a timing when the back-off timer value has expired.

7. The core node according to claim 2, wherein the at least one processor is further configured to execute the instructions to transmit an accept message to the radio terminal when the core node has recovered from the congestion state and the processing regarding the NAS request message has been completed.

8. A radio terminal comprising:
at least one memory storing instructions, and
at least one processor configured to execute the instructions to;
transmit a NAS request message to a core node; and
receive a response message in response to the NAS request message, wherein
the at least one processor is configured to execute the instructions not to transmit the NAS request message when it receives a Wait message indicating that processing regarding the NAS request message will be suspended from the core node and the at least one processor is configured to execute the instructions to re-transmit the NAS request message to the core node when it receives, from the core node, a reject message indicating that the processing regarding the NAS request message will not be executed.

9. The radio terminal according to claim 8, wherein the at least one processor is configured to execute the instructions to re-transmit the NAS request message to the core node after the back-off timer value configured in the reject message has expired.

10-11. (canceled)

12. A communication method in a radio terminal, the method comprising:
transmitting a NAS request message to a core node; and
receiving a response message in response to the NAS request message,
wherein, when the response message has been received, the NAS request message is not transmitted when a Wait message indicating that processing regarding the NAS request message will be suspended is received from the core node and the NAS request message is re-transmitted to the core node when a reject message indicating that the processing regarding the NAS request message will not be executed is received from the core node.

13-15. (canceled)
